(19) United States
(12) Patent Application Publication
(10) Pub. No.: US 2006/0000147 A1
(43) Pub. Date: Jan. 5, 2006

(54) Device and method for closing sliding doors

(76) Inventor: Norbert Pieper, Koblenz (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/151,125

(22) Filed: Jun. 13, 2005

Related U.S. Application Data
(63) Continuation-in-part of application No. PCT/DE03/04073, filed on Dec. 10, 2003.

(30) Foreign Application Priority Data
Dec. 13, 2002 (DE) DE 102 58 682.9

(51) Int. Cl. E05D 13/00

(52) U.S. Cl. 49/425

(57) ABSTRACT

A method and device for closing sliding doors are presented. The device includes a U-shaped channel having a carriage disposed therein. The carriage includes a plurality of wheels and side and bottom bores. The bottom bore is adapted to receive a portion of a connecting element and the side bore is adapted to receive a portion of a bolt. An electromechanical unit partially expels the bolt into the side bore, thus locking the sliding door.

### CROSS-REFERENCE TO RELATED APPLICATION

This is a continuation-in-part of International Application No. PCT/DE2003/004073 filed Dec. 10, 2003, the entire disclosure of which is hereby incorporated by reference herein.

### BACKGROUND OF THE DISCLOSURE

1. Field of the Disclosure

The disclosure generally relates to a device for closing doors, and specifically relates to a method and device for closing sliding doors.

2. Brief Description of Related Technology

German Preliminary Published Application DE 101 07 028 A1 describes a sliding door that can move horizontally on a running and guide rail and that is supported on rollers. In this context, the sliding door has a bolt that is configured as a stopper on one end face and that runs against a stop on the door when the sliding door is closed. At the top of the door, there is a catch of a two-stage latching element that can engage with a mandrel in a recess of the running and guide rail. When the bolt stops against the door when the latter is closed, the control bar connected to the bolt is slid lengthwise inside the door, thus releasing the mandrel that is pre-tensioned by means of a spring. As a result, the mandrel is moved vertically upwards and slid is into the locking position in the recess. By means of a separate handle situated on the front of the door, the mandrel is driven back into the door, which brings about a pre-tensioning of the spring that is mounted on the mandrel. At the same time, the bolt is pressed against the door frame. The door can be opened.

German Preliminary Published Application DE 36 02 440 A1 describes a running gear to guide the sliding movement of sliding windows, sliding doors, machine parts and the like. The running gear has a carriage that is guided in a U-shaped running rail, whereby the sliding windows or doors or machine parts are secured on said carriage by means of trunnions which, in turn, are elastically attached by means of bearing elements arranged on the carriage with elastomer components between them. The bearing elements are movable relative to the appertaining carriage. The bearing elements consist of a bearing bolt arranged in a transverse bore of the carriage, whereby the bearing bolt is circularly surrounded by at least one elastomer component. According to a preferred embodiment of the carriage, there are two elastomer components that serve to support the bearing bolt in the transverse bore, on both sides of the trunnion.

German Patent DE 195 33 153 C2 discloses a sliding door with an emergency opening or emergency closing mechanism. The sliding door consists of two door leaves, whereby these door leaves each run on two rollers along a guide rail that extends horizontally. Above the guide rail, one side of a helical spring is attached so as to be stationary while a second side of the helical spring is attached to an armature that holds a driving carriage, said helical spring using said armature to cooperate with a stationary electromagnet. The door leaves of the sliding door are driven in opposite directions by means of a drive motor, whereby the helical spring is tensioned during the closing of the door leaves by one of the two door leaves. The driving carriage acts on a stop mounted on the door leaf that causes the tensioning of the helical spring.

In an emergency situation—power failure—the armature is released from the electromagnet so that the driving carriage acts, via the stop, on the door leaf that tensions the helical spring and, via a toothed belt and a steel cable, it also acts on the second door leaf, whereby the two door leaves are pulled into the open position.

German Patent DE 41 06 117 C2 discloses a sliding door guide system for shower partitions and the like, which uses rigid guide elements to simplify the movement of at least one door segment in terms of its structure and its handling when the guide elements are latched into and unlatched out of a running groove. For this purpose, film hinges are arranged between an attachment foot and the running groove, whereby a profile section that can be flipped inwards or outwards can be locked in either of these positions. German Patent DE 199 08 191 C1 describes an automatic leaf or door system for actuating an actuation member of an additional actuation mechanism without using an additional drive means. Once at least one leaf of the leaf or door system has reached it closed position, a drive unit or drive transmission unit that is arranged parallel to the direction of movement of the leaf and permanently attached thereto can be moved further beyond a certain distance in the closing direction. The additional adjustment path is used to activate or to switch over the additional actuation mechanism. The additional actuation mechanism has a lever mechanism for manually activating or switching over the additional actuation mechanism.

The sliding door fittings described in German Preliminary Published Application DE 195 39 014 A1 can be used especially for glass doors. Here, a stationary profile rod is installed below a ceiling mechanism, a running rail for a carriage that can move on rollers being attached to said profile rod. The carriage, in turn, is connected to the glass door by means of glass hinges that act orthogonally to the running direction of the carriage. As a function of what is needed, different locking means prevent the carriage from derailing from the running rail. All of these means have in common the fact that a bolt arranged on the carriage grasps beneath a stop rail, whereby a driving pin that mechanically guides the bolt has shoulders to which the driving pin can be latched. In order to open and close the locking means, the bolt is moved in the horizontal plane towards or away from the stop rail.

German Patent DE 195 31 040 C2 describes a-sliding shutter for window or door elements that can be moved along a horizontal guide rail. The guide rail is preferably installed in a wall. In order to achieve low-friction movement of the sliding shutter, rollers attached to said shutter are used. The sliding shutter essentially allows two end positions. The first end position is reached when the sliding shutter is slid completely in front of the window or door element, whereas the second end position is reached when the sliding shutter is completely next to the window. When the sliding shutter is in one of the two end positions, an electromechanically activated bolt locks the sliding shutter in the appropriate position in that the bolt extends in an axis that runs vertically to the sliding direction, thus eliminating the only remaining degree of freedom of the sliding shutter.

The known sliding doors hardly or only unsatisfactorily ensure a continuous functionality of the sliding door mechanisms in case of a failure of external influencing variables that are needed for the proper functioning of the sliding doors.

It is the objective of the invention to refine an existing device in such a way as to provide a sliding door system with which the sliding door can be locked and unlatched as easily as possible.

### SUMMARY OF THE DISCLOSURE

The invention proposes configuring a sliding door arrangement using a closing mechanism attached to a stationary part of the sliding door in such a way that the closing mechanism has a hybrid structure and thus, especially but not exclusively, is suitable for use in sliding doors that are not actuated by another external means.

The term hybrid as employed in the present invention refers especially to an interaction with an electrical or electromagnetic component having a mechanical or pneumatic component.

In this manner, a sliding door system is created that ensures the desired functionality, even in situations in which external influencing variables are absent, and that has an especially design-optimized construction so as to ensure a high degree of security when the doors are closed.

Advantageously, the hybrid structure provides a closing technique that, on the basis of an electromechanical mechanism of action, exhibits a flexible functionality that is adapted to the external circumstances of the device.

This has the advantage that the closing means can be realized without additional construction work on the sliding door. The sliding door itself preferably has a means for movement guidance. This advantageous refinement of the invention allows the use of numerous different sliding door materials since an additional construction measure for locking that is independent of the sliding door material is not necessary.

Especially advantageous door materials are glass, wood, plastics, metals, safety materials, fire-protection material or composite materials.

An especially preferred embodiment of the invention provides a mechanism that brings about an unlocking of a locked sliding door in case of an absence of all of the external signals needed for the system-related functioning of the sliding door system.

An example of a situation for purposes of illustrating the resultant advantages can be, for example, the case of a room security system. If this room security system is designed, among other things, in such a way that external triggering signals bring about the closing of one or all of the sliding doors in a room complex, then the question arises as to the function status of each of the sliding doors in case of a spontaneous but prolonged absence of all external signals.

The device according to the invention for closing sliding doors ensures that a sliding door is unlocked even, for example, during a power failure, and thus makes it possible for persons or animals who are located inside the room that is delimited by the sliding door to leave the room. This situation is of crucial importance when it comes to the protection of persons or animals.

The term room includes, for example, offices, residential rooms, commercially used spaces, public facilities or separated areas for keeping animals.

The external signals needed for the system-related functioning of the sliding door system can be of any type and form, whereby encoded as well as unencoded signal quantities can be used.

### BRIEF DESCRIPTION OF THE DRAWINGS

FIG. 1 is a side cutaway view of a device constructed in accordance with the teachings of the disclosure.

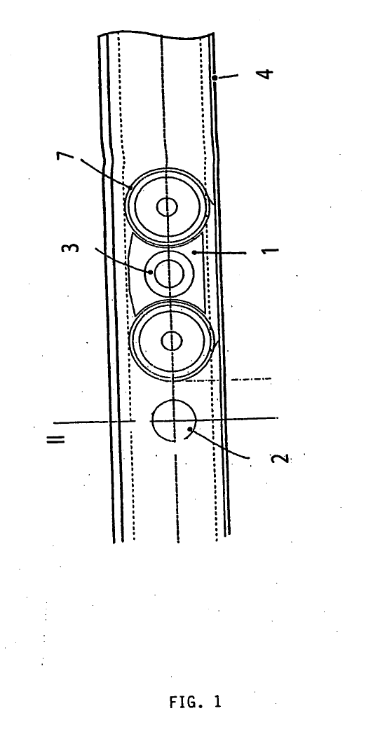

FIG. 2 is a forward cross section through the device shown in FIG. 1.

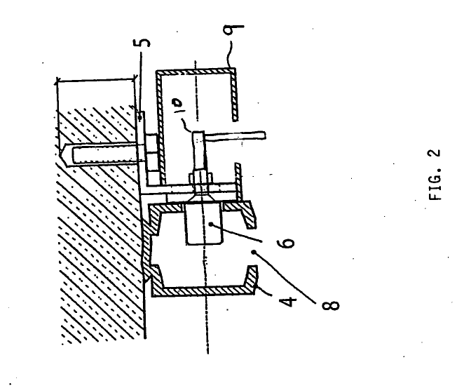

FIG. 3 is a top cutaway view of the device of FIG. 1.

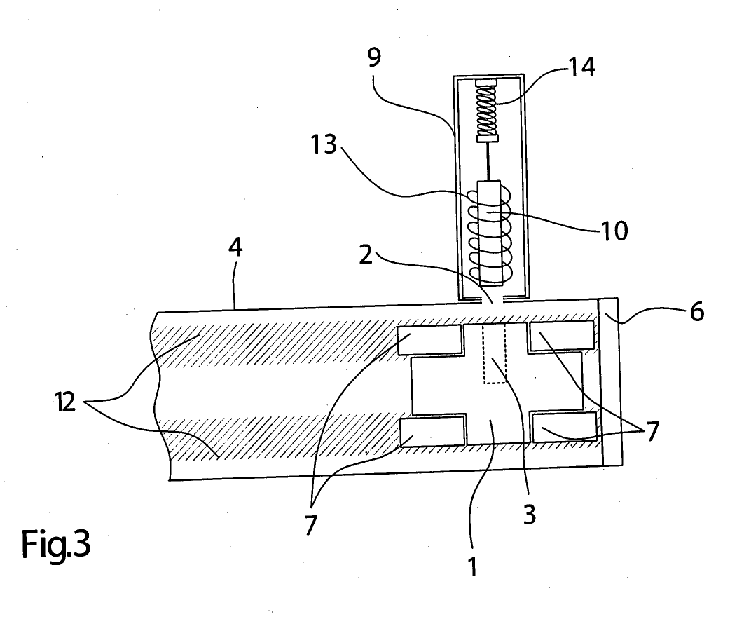

FIG. 4 is a bottom view of a carriage of the device of FIG. 1.

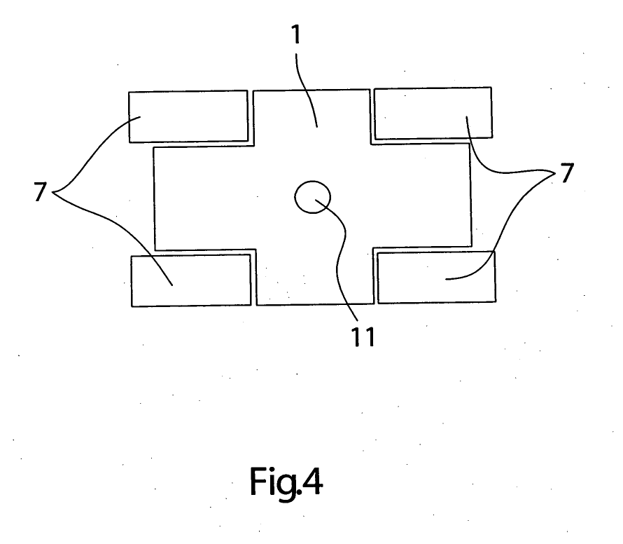

### DETAILED DESCRIPTION

The depicted preferred device according to the invention is structured in such a way that a sliding door can be slid by means of at least one carriage 1 parallel and relative to a running rail 4 that is attached to a wall or below a ceiling. Here, the running rail 4 is installed so as to be stationary and it has a U-shaped cross section that is configured in such a way that the carriage 1 supported on rollers 7 can move in the U-shaped cross section along the longitudinal extension of the running rail 4. The part of the U-shaped cross section that is not closed is referred to below as the gap 8 of the running rail 4, whereby the gap 8 preferably faces downwards in the direction of the floor, so that a connection is advantageously established through the gap 8 of the running rail 4 by means of a connection element between the carriage 1 and the sliding door.

Due to the resultant hanging structure of the sliding door attached to the carriage 1, a sliding door device can be provided that is extremely easy to maintain and simple to manufacture. Moreover, the advantageous arrangement of the carriage 1 in the running rail 4 results in an especially compact device since the space requirement of such an arrangement concept is much less than that required for a device in which the carriage moves along outside of the running rail and in which the connection element is arranged around the carriage between the carriage and the sliding door.

In another advantageous embodiment, a second running rail 4, once again comprising at least one carriage 1, is installed on the bottom below the sliding door. The advantage of a second running rail 4 that is located at the lower edge of the sliding door lies in the additional guide element, which leads to a further stabilization of the movement process of the sliding door along the running rail 4.

The carriage 1 is preferably configured in such a way that, on the front part as well as on the back part of a rectangular compact body, there are two axles with rollers 7 at each end. On each side of the rectangular body along its longitudinal extension, there is a cut-out whose geometrical shape is preferably a sector of a circle. The circle diameter of the sector is determined by the order of magnitude of the diameter of the rollers 7.

As a result, all of the preferably four rollers 7 mounted on a carriage 1 extend into the rectangular body, which allows an extremely compact structure of the complete carriage 1. The gap between the outer surface of the rollers and the cut-out on the rectangular body is advantageously only a few millimeters. In particular, the gap is approximately 0.1 mm to 100 mm, whereby values between 1 mm and 30 mm are especially preferred.

On the bottom of the carriage 1, there is a thread 11 extending inwards by means of which the connection element mounted on the sliding door permanently and securely establishes contact With the carriage 1 via a screwed connection. Since the connection element is constantly in contact with the sliding door, any relative movement of the carriage 1 with respect to the stationary running rail 4 is coupled to a movement of the sliding door.

Preferably, there are a total of two carriages 1 in one running rail 4 since this enhances the stability of the sliding door system. As a rule, the ultimate criterion for determining the absolute number of carriages 1 depends on the length of the running rail and/or on the weight of the sliding door.

Furthermore, at least one carriage 1 per running rail 4 has a bore 3 at one of its two lateral faces as well as a small magnet that is stationarily attached to the carriage 1. In the case that the sliding door is locked, the bore 3 is used to accommodate a bolt 10 that can be actuated by a rectangular electromechanical unit 9 that is attached to the running rail 4. In this manner, the degree of freedom of the carriage 1 that accommodates the bolt 10 is eliminated and the carriage and hence also the sliding door is held in place in the running rail 4.

The running surfaces 12 in the running rail 4 are two short projections extending over the entire length of the running rail, whereby the projections run facing each other at the ends of the two walls of the U-shaped running rail 4 but are not in contact with each other along this extension, thus resulting in a gap between the running surfaces. The carriages 1 can be accommodated completely movably in the running rail 4 with this type of configuration for the running rail 4 or for the appertaining running surfaces 12. The running surfaces 12 of the running rail 4 allow a low-friction rolling of the rollers 7 of the carriage 1.

The gap between the running surfaces 12 is at least so large that the screwed connection between the carriage 1 located in the running rail 4 and the connection element of the sliding door can be established without any hindrance.

The degree of freedom of the carriage 1 is inhibited by at least two end pieces 6 mounted along the running rail 4.

In an especially preferred embodiment, the running rail 4 is made of aluminum, which has the advantage that it is an especially lightweight unit while, at the same time, the running rail 4 retains a high torsion stiffness as a result of its U-shaped profile.

This has the additional advantage that even heavy sliding doors can be attached to the rollers without the running rail 4 that holds the rollers 7 becoming deformed during the course of the use of the sliding door system in such a way that would preclude the proper functioning of the system.

The running rail 4 is attached by means of a fastening angle bracket to a load-bearing element, whereby, in an especially preferred embodiment, at least two fastening angle brackets are attached to the two points along the running rail 4 that correspond to the selected end points of the carriage. In this manner, the above-mentioned end pieces 6 can be mounted onto the fastening angle brackets in order to limit the horizontal degree of freedom of a carriage 1, which allows an especially elegant solution for attaching the end pieces 6.

In principle, the end pieces 6 can be attached at any desired position along the running rail 4 by means of a bore on one of the two lengthwise sides of the U-shaped profile, so that even changed ambient situations, for example, resulting from a changed door passage area, can be subsequently accommodated.

The electromechanical unit 9 which, in case of locking, blocks at least one carriage 1, is preferably attached at the level of the running rail 4 installed below the ceiling whereby, as an alternative, also in case of another running rail 4 located on the floor, it is also possible to block at least one carriage 1 of this running rail 4 by means of the electromechanical unit 9 when in the locked position.

In another embodiment, the electromechanical unit 9 is mounted directly onto the running rail 4.

The electromechanical unit 9 is preferably only installed once the entire sliding door assembly has been mounted, that is to say, only once the sliding door can already be freely moved along the guide rail mounted at the place of installation. Subsequently, the two end pieces 6 are affixed, whereby the final position of the end pieces 6 is defined by the passage area left open by the sliding door.

The sliding door is then placed into the final position in which the space behind the passage area is no longer accessible. This position of the sliding door corresponds to the position from which the sliding door can no longer be moved when it is locked. In this position of the sliding door, at least one carriage 1 is in contact with an end piece 6. The exact position of the bore 3 of the carriage 1 used for the locking is measured on the side where the carriage 1 is in contact with an end piece 6.

At the level of the vertical projection of the bore 3 on the carriage 1 on the running rail 4, the running rail 4 is now provided with a bore 2 whose diameter corresponds to that of the bore 3 of the carriage 1, so that the two opposing bores 2, 3 are exactly lined up along their connection line.

The end face of the metal housing of the rectangular electromechanical unit 9 has a circular opening from which the bolt 10 can extend vertically to the end surface. An electromechanical drive is used to expel the bolt 10 from the housing, and this is done in response to an external control signal. If the bolt 10 is not in its resting position, the position in which the bolt 10 is completely retracted into the housing, a spring force acts on the bolt 10 so as to counter the movement of the bolt 10 when it is expelled from the spool 13. As a result, the force that expels the bolt 10 out of its resting position acts in the opposite direction to the spring force. The term spring force here is not limited to a force generated by a spring 14 but rather also comprises forces having the same effect which can be generated, for example, by a pneumatic means.

Another especially advantageous embodiment uses a constant current flow as an external signal. External signals are an especially preferred example of control signals according to the invention. A spool 13 installed inside the electromechanical unit 9 is thus supplied with the constant current flow, so that a voltage is induced. The Lorentz force resulting from this physical process is oriented in such a way that the bolt 10, which is in the resting position inside the spool 13, is partially expelled in accordance with its degree of freedom out of the spool 13 and thus out of the housing. The bolt 10 is dimensioned in such a way that an end position of the bolt 10, that is to say, when the bolt 10 has traversed the maximum distance out of the spool 13, is sufficient to extend through the bore in the running rail 4 as well as through the bore 3 on the carriage 1.

As long as the external signal, that is to say in this embodiment the current flow, is present at the electromechanical unit 9, the bolt 10 is in the end position. The sliding door is locked.

This yields an especially advantageous embodiment of the device according to the invention since the sliding door system is configured in such a way that an absence of the external signal allows the bolt 10 to remain only under the influence of the spring force. As a consequence of this especially advantageous approach, the sliding door is unlocked if the external signal is absent, since in this situation, the bolt 10 is returned to its resting position under the influence of the spring force.

Another embodiment stands out for the fact that, in addition to the above-mentioned operation of the bolt 10, a mechanical device is attached to the electromechanical unit 9 by means of which manual unlocking of the sliding door is made possible, independent of the external signals. For this purpose, there is a slit-type opening on the bottom of the rectangular housing from which a narrow, approximately 10 mm-long pin extends. A movement of the pin along the longitudinal extension of the slit-type opening causes the mechanical retraction of the bolt 10 until the resting position of the bolt 10 in the spool 13 is reached.

The pin for the manual unlocking of the sliding door has a thread with which an additional means for actuating the manual unlocking means can be attached in order to lengthen the pin.

Another especially preferred embodiment of the device according to the invention only triggers a locking operation if the magnet fastened to a carriage 1 induces a voltage within the electromechanical device 9, whereby the carriage 1 is preferably situated in an end position for this purpose.

### LIST OF REFERENCE NUMERALS

1 carriage
2 bore on the running rail
3 bore on the carriage
4 running rail
5 fastening angle bracket
6 end piece
7 rollers on the carriage
8 gap
9 electromechanical unit
10 bolt
11 thread
12 running surface
13 spool
14 spring

1.-20. (canceled)

21. A device for closing sliding doors, the device comprising:
a stationary running rail having a U-shaped cross section;
a carriage disposed within the rail, the carriage having two end faces, a plurality of rollers and a bore disposed on a side thereof;
a connecting element attached to the carriage at a first end and adapted to attach to a sliding door at a second end; and
an electromechanical unit mounted on the rail, the electromechanical unit having a housing and a movable bolt adapted to extend through a bore in the rail and at least partially into the bore on the carriage upon receipt of a control signal.

22. The device of claim 20, wherein the electromechanical unit includes a slit-type opening on the bottom of the housing and a pin protruding through the opening and wherein movement of the pin along the opening moves the bolt.

23. The device of claim 22, wherein the pin is threaded at one end to receive an extension.

24. The device of claim 21, wherein the bolt is biased to a retracted position.

25. The device of claim 24, wherein the bolt is biased with a spring.

26. The device of claim 21, wherein the control signal is a constant current flow.

27. The device of claim 21, wherein the bolt is disposed within a spool supplied with a constant current flow, and wherein a Lorentz force resulting from the current flow through the spool partially extends the bolt out of the spool.

28. The device of claim 21, wherein the carriage includes two axels, each axel having two rollers and wherein the carriage body has a cut-out portion, the cut-out portion having a generally arcuate shape.

29. The device of claim 21, wherein each cut-out portion substantially receives a portion of one of the rollers and wherein a gap between the roller and the cut-out portion is in the range of approximately 1 mm to approximately 30 mm.

30. The device of claim 21, wherein the carriage has a threaded bore sized and shaped to receive one end of the connecting element.

31. The device of claim 21, further including at least one end piece mounted along the rail.

32. The device of claim 31, wherein the at least one end piece is attached to the rail through a bore on a lengthwise side of the rail.

33. The device of claim 21, wherein the rail is made of aluminum.

34. The device of claim 21, wherein the rail is attached to a load bearing element with a fastening angle bracket.

35. The device of claim 34, wherein the at least one end piece is attached to the fastening angle bracket.

36. The device of claim 21, including a second running rail.

37. The device of claim 21, including a sliding door attached to the connecting element, wherein the sliding door delimits a space in one of a commercial area, a public facility, an office, a residential room or an animal retention area.

38. The device of claim 37, wherein the sliding door includes one of the following materials, glass, wood, plastic, metal, safety material, fire-protection material or composite material.

39. A method for closing a sliding door, the method comprising:
inducing a voltage within an electromechanical device with a magnet attached to a carriage;
supplying a control signal that is a constant current flow to a spool;
using a Lorentz force generated by the constant current flow to partially extend a bolt disposed within the spool through a bore in a running rail and partially into a bore in the carriage that is attached to the sliding door.

40. The method of claim 39, wherein the bolt is biased to a retracted position.

41. The method of claim 40, wherein absence of the control signal allows the bolt to return to the retracted position.
